(19) United States
(12) Patent Application Publication
(10) Pub. No.: US 2017/0236224 A1
(43) Pub. Date: Aug. 17, 2017

(54) Identifying Points of Interest

(71) Applicant: CoStar Realty Information, Inc., Washington, DC (US)

(72) Inventors: Andrew Florance, San Francisco, CA (US); Heidemarie W. Williams, Homer Glen, IL (US); Adam Fischer, Mokena, IL (US)

(21) Appl. No.: 15/042,789

(22) Filed: Feb. 12, 2016

(51) Int. Cl. G06Q 50/16; G06F 17/30

(52) U.S. Cl. CPC G06Q 50/16; G06F 17/3053; G06F 17/3087; G06F 17/30241

(57) ABSTRACT

Methods, including computer programs encoded on a computer storage medium, for enhancing point of interest identification. In one aspect, a method includes: receiving a query that specifies a geographic region, obtaining a obtaining a set of resources that (i) are identified as responsive to the query and (ii) each include listing information for one or more properties located within the geographic region, making one or more determinations about a particular resource among the set of resources, ranking the particular resource among the set of resources based at least on the one or more determinations, and providing an indication of the particular resource's ranking among the set of resources.

### FIELD

The present specification relates to search engines.

### BACKGROUND

In recent years, online search services have changed the way that people obtain information on assets and services of their interest. Users are now able to navigate up-to-date listings for assets and services using a variety of different communication devices (e.g., smart phones, personal computers, personal digital assistants (PDAs), etc.), and are doing so with increasing regularity.

### SUMMARY

Although users of online real estate search services may have vast amounts of real estate information at their fingertips, they are often faced with the burdensome task of sifting through listings that include outdated information, listings for properties that are not available within a relevant timeframe, and listings that include information that is unreliable or provided by untrusted sources. The techniques described herein may, for instance, be leveraged by websites or mobile applications associated with online real estate services to enhance user experience by more quickly connecting users with property listings that are reliable and relevant and providing users with insight into real estate markets and information that promotes greater financial awareness.

In some aspects, the subject matter described in this specification may be embodied in methods that may include the actions of receiving a query that specifies a geographic region, obtaining a obtaining a set of resources that (i) are identified as responsive to the query and (ii) each include listing information for one or more properties located within the geographic region, making one or more determinations about a particular resource among the set of resources, ranking the particular resource among the set of resources based at least on the one or more determinations, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

In some aspects, the subject matter described in this specification may be embodied in methods that may include the actions of receiving a query that specifies a geographic region, obtaining a set of resources that (i) are identified as responsive to the query and (ii) each include listing information for one or more properties located within the geographic region, determining that a particular resource among the set of resources includes listing information that was last updated within a predetermined amount of time, ranking the particular resource among the set of resources based at least on determining that the particular resource among the set of resources includes listing information that was last updated within a predetermined amount of time, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. In some implementations, the actions may further include determining that a particular amount of time has elapsed since the particular resource was last updated. In these implementations, determining that the particular resource among the set of resources includes listing information that was last updated within the predetermined amount of time may include determining that the particular amount of time is less than or equal to the predetermined amount of time.

In some examples, the actions may further include generating one or more representations of the particular resource, at least one of which indicates that the particular amount of time has elapsed since the particular resource was last updated. In such examples, providing the indication of the particular resource's ranking among the set of resources may include providing the one or more representations of the particular resource, with indication of the particular resource's ranking among the set of resources, for output. In addition, the actions may, in some of these examples, further include determining that the particular resource includes listing information for one or more properties that reside at a particular location within the geographic region. In these examples, generating one or more representations of the particular resource may include generating one or more representations of the particular resource, at least one of which indicates the particular location within the geographic region.

In some aspects, the subject matter described in this specification may be embodied in methods that may include the actions of receiving a query that specifies a geographic region, obtaining a set of resources that (i) are identified as responsive to the query and (ii) each include listing information for one or more properties located within the geographic region, determining whether a particular resource among the set of resources includes listing information for one or more properties that are indicated as available for occupancy at a particular point in time, ranking the particular resource among the set of resources based at least on determining whether the particular resource among the set of resources includes listing information for one or more properties that are indicated as available for occupancy at the particular point in time, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, determining whether the particular resource among the set of resources includes listing information for one or more properties that are indicated as available for occupancy at the particular point in time may, in some implementations, include determining whether the particular resource among the set of resources includes listing information for one or more properties that are indicated as currently available for occupancy.

In some examples, receiving the query that specifies the geographic region may include receiving, at a first point in time, a query that specifies a geographic region. In such examples, determining whether the particular resource among the set of resources includes listing information for one or more properties that are indicated as available for occupancy at the particular point in time may include determining whether the particular resource among the set of resources includes listing information for one or more properties that are indicated as becoming available for occupancy within a particular amount of time after the first point in time.

In some implementations, the actions may further include determining whether the particular resource among the set of resources includes listing information that is managed at least in part by one or more users of a sponsored account. In such implementations, ranking the particular resource among the set of resources may, for instance, include ranking the particular resource among the set of resources based further on determining whether the particular resource among the set of resources includes listing information that is managed at least in part by one or more users of a sponsored account.

In some aspects, the subject matter described in this specification may be embodied in methods that may include the actions of receiving a query that specifies a geographic region, obtaining a set of resources that (i) are identified as responsive to the query and (ii) each include listing information for one or more properties located within the geographic region, determining that a particular resource among the set of resources includes listing information that was supplied through a particular listing information interface, ranking the particular resource among the set of resources based at least on determining that the particular resource among the set of resources includes listing information that was supplied through the particular listing information interface, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, wherein determining that the particular resource among the set of resources includes listing information that was supplied through the particular listing information interface may, in some examples, include determining that the particular resource among the set of resources includes listing information that was supplied through a user interface.

In some implementations, determining that the particular resource among the set of resources includes listing information that was supplied through the particular listing information interface may include determining that the particular resource among the set of resources includes listing information that was supplied through an application programming interface.

In some examples, the actions may further include further include determining that the particular resource includes listing information for one or more properties that reside at a particular location within the geographic region and generating one or more representations of the particular resource, at least one of which indicates the particular location within the geographic region. In such examples, providing the indication of the particular resource's ranking among the set of resources may include providing the one or more representations of the particular resource, with indication of the particular resource's ranking among the set of resources, for output.

In some aspects, the subject matter described in this specification may be embodied in methods that may include the actions of receiving a query that specifies a geographic region and a price range, obtaining a set of resources that (i) are identified as responsive to the query and (ii) each include listing information for one or more properties located within the geographic region, determining that a particular resource among the set of resources includes listing information for one or more properties having prices that exceed the price range by a particular amount, ranking the particular resource among the set of resources based at least on determining that the particular resource among the set of resources includes listing information for one or more properties having prices that exceed the price range by the particular amount, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, receiving the query that specifies the geographic region and the price range may, in some implementations, include receiving a query that specifies a geographic region and a price range that extends from a lower limit to an upper limit. In such implementations, the actions may further include based at least on the received price range, determining a particular price range that (i) is different from the received price range and (ii) extends from the upper limit of the received price range to another limit that exceeds the upper limit of the price range.

In some examples, determining that the particular resource among the set of resources includes listing information for one or more properties having prices that exceed the price range by the particular amount may include determining that the particular resource among the set of resources includes listing information for one or more properties having prices that fall within the particular price range.

In some implementations, the actions may further include generating one or more representations of the particular resource, at least one of which indicates that the particular resource includes listing information for one or more properties having prices that fall within the particular price range. In such implementations, providing the indication of the particular resource's ranking among the set of resources may include providing the one or more representations of the particular resource, with indication of the particular resource's ranking among the set of resources, for output.

In some aspects, the subject matter described in this specification may be embodied in methods that may include the actions of receiving a query that specifies a geographic region, obtaining a set of resources that (i) are identified as responsive to the query and (ii) each include listing information for one or more properties located within the geographic region, determining that a particular resource among the set of resources includes listing information for one or more properties that have a particular attribute that has been indicated as verified by a third party listing information verification service, ranking the particular resource among the set of resources based at least on determining that the particular resource among the set of resources includes listing information for one or more properties that have the particular attribute that has been indicated as verified by the third party listing information verification service, and providing an indication of the particular resource's ranking among the set of resources.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other versions may each optionally include one or more of the following features. For instance, determining that the particular resource among the set of resources includes listing information for one or more properties that have the particular attribute that has been indicated as verified by the third party listing information verification service may, in some implementations, include determining that the particular resource among the set of resources includes listing information for one or more properties that has been indicated by the third party listing information verification service as being owned or managed by an entity having earned one or more certifications.

In some examples, determining that the particular resource among the set of resources includes listing information for one or more properties that have the particular attribute that has been indicated as verified by the third party listing information verification service may include determining that the particular resource among the set of resources includes listing information for one or more properties that has been indicated by the third party listing information verification service as being owned or managed by an entity having passed a background check.

In some implementations, the listing information of the particular resource indicates one or more features or amenities of one or more properties. In such implementations, determining that the particular resource among the set of resources includes listing information for one or more properties that have the particular attribute that has been indicated as verified by the third party listing information verification service may include determining that the particular resource among the set of resources includes listing information for one or more properties have been indicated as verified by the third party listing information verification service to include the one or more features or amenities.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1 illustrates an example search engine system for enhancing point of interest identification.

FIG. 2 illustrates an example graphical user interface for displaying a set of search results.

FIGS. 3A-D illustrate exemplary graphical user interfaces for displaying sets of search results that are ranked in corresponding exemplary manners.

FIG. 4 is a flowchart of an exemplary process for enhancing point of interest identification.

FIG. 5 is a diagram of exemplary computing devices.

Like reference symbols in the various drawings indicate like elements.

### DETAILED DESCRIPTION

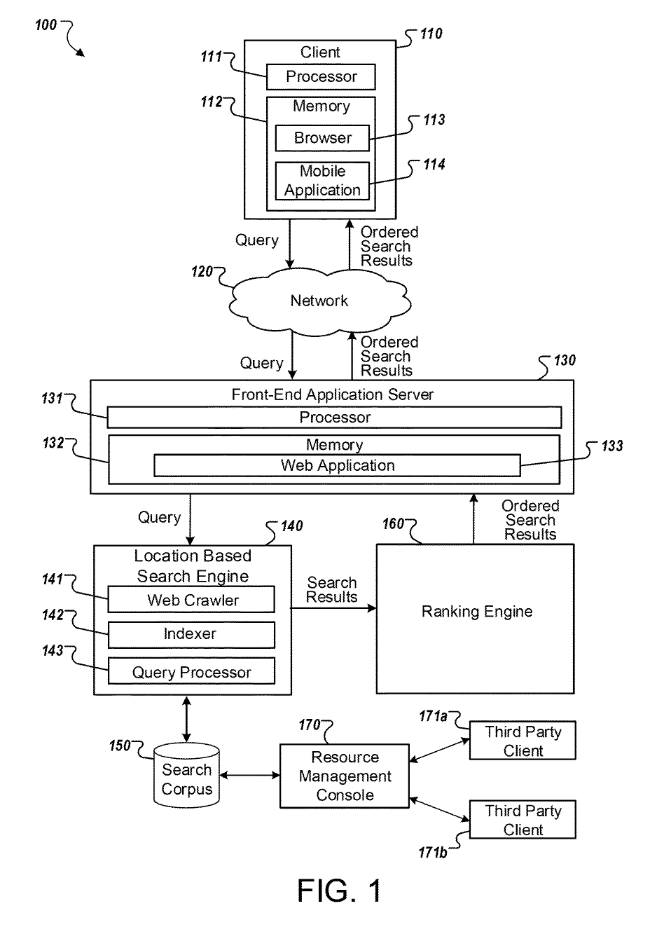

FIG. 1 depicts an example search engine system 100 for enhancing point of interest identification, according to one example implementation. The system 100 may include a client device 110, a network 120, a front-end application server 130, a location based search engine 140, a search corpus database 150, and a ranking engine 160.

Client device 110 may be representative of one, or multiple, client devices. The client device 110 may include a mobile computing platform or a non-mobile computing platform. Mobile computing platforms may include, for example, a smartphone, tablet, laptop computer, or other thin client devices. Non-mobile computing platforms may include, for example, desktop computers, set top box entertainment systems, video game consoles, or the like. Client device 110 may be configured to communicate with front-end application server 130 via network 120 using one or more communication protocols.

The client device 110 of system 100 may include at least a processor 111 and a memory 112. The memory 112 may provide for the storage of computer program code associated with one or more applications installed on client 110. The applications may include, for example, a browser 113 or mobile application 114. Processor 111 may be configured to execute the stored computer program code in a manner that allows client 110 to realize the functionality provided by the applications. Processor 111 may also be configured to execute instructions to realize the functionality associated with any of the actions attributed to client 110 below.

The client 110 may be able to access one or more web based applications 133 hosted by front-end application server 130 via network 120 using browser 113. Such web based applications may include, for example, an application that facilitates identification of resources that include information for one or more properties or other entities that may be available for sale, for lease, or that provide a particular service. An entity may include any item that may be available for sale or lease such as, for example, a book, a clothing item, a motor vehicle, a consumer electronic item, a house, an apartment, or the like. Alternatively, an entity may include a party that provides a service such as, for example, a restaurant, a barber shop, a day care facility, a school, a doctor's office, a law office, a government agency, or the like. Web application 133 may utilize one or more back-end components in order to identify one or more resources that include information for one or more entities based on search input parameters. In certain instances, web application 133 may utilize the methods set forth herein to identify a set of one or more resources that are responsive to a query and include listing information for one or more properties, or information for one or more other entities.

Identification of resources may be achieved by using client device 110 to search one or more databases such as, for example, search corpus database 150 and then using one or more back-end components to identify and return ordered search results to client device 110. In some examples, the returned search results include graphical and/or textual representations of corresponding resources and the information included in the corresponding resources. A user may initiate a search with client device 110 by interacting with one or more search fields provided by web application 133 via a browser 113. For instance, a user may provide an input into a search field that can be used as at least a portion of a search query. Then, the user may instruct the client device 110 to transmit the search query to front-end application server 130 via network 120. Alternatively, or in addition, a user may input a search query by drawing one or shapes around a location of interest on a map provided by a graphical user interface. Client device 110 may then generate a query to identify resources that include listing information for one or more properties that may reside within geographic locations associated with the one or more shapes drawn by the user on the map provided by a graphical user interface, and transmit the query to front-end application server 130. The front-end application server 130 may then forward the query to one or more back-end data processing systems that may execute the search query. The backend system may identify a set of search results in response to the search query, such as a set of resources that include listing information for one or more properties, rank each search result in the set of search results, and then return the set of search results that are responsive to the received query to the front-end application server 130. The front-end application server 130 may then forward the search results back to client device 110.

The search results may be displayed on a graphical user interface associated with client device 110 in a variety of different ways that may assist a user in understanding and interpreting the search results. For instance, representations of the search results may be displayed as a list, wherein each representation in the list is ordered according to a rank determined by one or more backend components of system 100 such as, for example, ranking engine 160. Alternatively or additionally, the search results may be represented as graphical icons that are plotted on a map of a geographical area and each correspond to a particular resource identified as a search result that is responsive to a received search query. The location of each graphical icon on the map may be indicative of the location of one or more properties for which the corresponding resource includes listing information. In certain instances, search results may be displayed as both a ranked list in a first portion of the graphical user interface and as a plot of graphical icons on a map in a second portion of the graphical user interface. Other ways of displaying search results also fall within the scope of this specification.

Separate from browser 113, a client device 110 may also be able to use a mobile application 114 in order for a user of client device 110 to avail himself of the same, or similar, functionality that was described above as being provided by a web application 133 via browser 113. Mobile application 114 may include an executable software program that was previously downloaded from a mobile application provider. Mobile application 114 may be configured to relay commands input by a user such as, for example, search queries to the front-end application server 130. After receiving a search query from mobile application 114, the front-end application server 130 may request that one or more backend components execute the search query, rank the search results, and then return the ranked search results to mobile application 114, which may display the search results as a ranked list of resources that each include listing information for one or more properties, as plotted graphical icons on a map, or a combination thereof.

Network 120 may be configured to facilitate connectivity between a client device 110 and the front-end application server 130. Client 110 and front-end application server 130 may be connected to network 120 via one or more wired, or wireless, communication links. Network 120 may include any combination of one or more types of public and/or private networks including but not limited to a local area network (LAN), wide area network (WAN), the Internet, a cellular data network, or any combination thereof.

Front-end application server 130 may include at least a processor 131 and a memory 132. The memory 132 may provide for the storage of computer program code associated with one or more applications hosted by front-end application server 130. The applications may include, for example, a web application 133 that may facilitate identification of resources that include listing information for one or more particular properties that may be available for sale, for lease, or that provide a particular service. Processor 131 may be configured to execute the stored computer program code in a manner that allows front-end application server 130 to realize the functionality provided by the applications. Processor 131 may also be configured to execute instructions to realize the functionality associated with any of the actions attributed to front-end application server 130 below.

Front-end application server 130 may serve as an interface between the client 110 and the back-end components of system 100 that may include, for example, a location based search engine 140, search corpus database 150, and ranking engine 160. Front-end application server 130 may be comprised of one or more server computers. Front-end application server 130 may be configured to receive commands from a client device 110, and translate those commands, if necessary, into a format that is compatible with one or more back-end network components. Front-end application server 130 may also employ network security applications such as, for example, a firewall, user authentication, subscription verification, or the like in an effort to supervise access to one or more back-end network components, if necessary.

Front-end application server 130 may also facilitate session management for each browsing session initiated by each respective client device 110 that is currently using a browser 113, or mobile application 114, to avail itself of the services provided by the web application 133. For instance, front-end application server 130 may employ functionality to associate an identifier with each query received by the front-end application server 130 from a particular client 110. The front-end application server 130 may later utilize the identifier in order to associate ordered search results received from a ranking engine 160 with a query received from a particular client 110. The identifier may then be used to return the set of ordered search results to the client device 110 that initiated the query. The identifier may include a user identifier, device identifier, transaction identifier, or the like.

System 100 may also include a location based search engine 140. Location based search engine 140 may be configured to receive and execute search queries that are associated with a location component. The location component of the search query may be based on a particular location that was input by a user via client device 110. The location component may be the location of the particular client device 110, or some other location that the user of client device 110 has input as a search parameter. Alternatively, the location component of the search query may be obtained by front-end application server 130, a back-end network component, or another network component associated with system 100 based on one or more attributes associated with a client device 110. For instance, one of the aforementioned network components may determine the current location of a client device 110. Alternatively, the current location of a client device 110 may be provided to one or more network components of system 100 by a third party. Alternatively, the location component may be determined based on locations that the client device 110 has recently traveled. The location component may include, for example, a neighborhood, a city, a state, a zip code, GPS coordinates, longitude and latitude coordinates, or the like.

Location based search engine 140 may include a web crawler 141, an indexer 142, and a query processor 143. The location based search engine 140 may be hosted by one or multiple server computers. The server computer(s) hosting the location based search engine 140 may be the same server computer(s) that provide the front-end application server 130. Alternatively, however, the server computer(s) hosting the location based search engine 140 may be a different set of one or more server computer(s) that are configured to communicate with the front-end application server 130 via one or more public or private networks.

Web crawler 141 may be configured to traverse computers connected to a computer network such as, for example, the Internet, to scan and identify data associated with particular properties. For instance, web crawler 141 may scan computers associated with a computer network in order to identify resources such as web pages and other files accessible via the computer network that may include data associated with one or multiple properties that are currently being offered for sale or lease. Alternatively, or in addition, web crawler 141 may scan computers associated with a computer network in order to identify resources that may include data associated with one or more services. The identified resources or a subset of the raw data associated therewith may be stored in search corpus database 150. In some implementations, web crawler 141 may be autonomous software that is configured to periodically scan computer networks in order to identify new, or previously undiscovered, web pages, network accessible files, or other resources associated with one or more properties that are currently being offered for sale, for lease, or resources associated with one or more services. Alternatively, or in addition, the functionality of web crawler 141 may be performed by one or more operators of location based search engine 140. For instance, a group of one or more analysts may obtain raw data associated with a property, and store the raw data in search corpus database 150. Alternatively, or in addition, it is contemplated that a party that offers a property for sale, for lease, or that provides a service may also upload raw data associated with the property to search corpus database 150.

The aggregated set of raw data stored in search corpus database 150 may comprise a wealth of data describing a wide spectrum of different properties. For instance, search corpus database 150 may include for each known property, for example, the name of the property, the property's location, a description of the property, a value associated with the property, or the like. The value for the property may include, for example, the price of a property that is being offered for sale or for lease. Alternatively, however, the value for a property may include, for example, a property rating. Other types of raw data associated with a property may be obtained via the data crawling process and stored in search corpus database 150.

In some examples, the system 100 further includes a resource management console 170, through which a variety of third parties may manage one or more resources or other information contained in search corpus database 150. Third parties, such as property managers, landlords, property owners, and real estate agents may access one or more resources that are associated with the respective third party's account. In this way, such third parties may be able to post and manage listing information for various properties that are searchable to users. A third party may, for instance, initially register an account through interaction with the resource management console 170, and later access their account to, for example, add a new listing information for properties that properties that are currently available or will become available in the near future, remove listing information for properties that have been taken off of the market, update listing information for properties, and the like. Third parties may use any of a variety of client devices, such as third party clients 171a-171b, to interact with resource management console and search corpus database 150. Such third party clients 171a-171b may function in a manner similar to that of client 110, and may communicate with resource management console 170 over network 120 or one or more networks that are similar to that of network 120. In some examples, such third parties may manage resources for properties on any of a number of scales. For instance, a property management company may manage a web page for a particular apartment building or community, and may further manage elements or sub-pages of this web page for apartments or units within the particular apartment building or community.

Indexer 142 may be configured to analyze the raw data obtained during the crawling process in order to make the raw data searchable. For instance, indexer 142 parse the raw data and extract one or more types of relevant data. For example, the indexer 142 may analyze the raw data to extract a property's name, a property's location, and a value associated with the property. Indexer 142 may than associate the extracted data with one or more keywords. The associated keywords may be compared to aspects of received search queries in order to determine whether the extracted data associated with the keywords is responsive to the search query.

Query processor 143 may be configured to receive a search query from front-end application server 130 that originated at a client device 110. Query processor 143 may be configured to parse the received query, extract any relevant keyword(s) from the received query, and then execute the query against the index generated by indexer 142. Query processor 143 may alter the form of one or aspects of the received query. For instance, query processor 143 may alter one or more keywords in order to expand or narrow the scope of a received query, as necessary. Such alterations to keywords of a query may include, for example, utilizing a root expander, replacing one or more characters with a wildcard character, insertion of one or more Boolean operators between keywords, dynamically altering location information associated with the query, or the like. Query processor 143 may also translate one or more aspects of the received query in order to make the query compatible with the index that is associated with the search corpus database 150. Query processor 143 may then execute the query against the search corpus database 150. Execution of the search query against the search corpus 150 may yield a set of one or multiple search results. The search results may identify, for example, a group of one or multiple links that are associated with resources that are responsive to the query received from client 110. The search result links may reference a resource that includes information associated with one or more properties. For instance, the search result links may reference web pages that include listing information for one or more properties. The information included in each resource may be drawn from search corpus database 150. The set of search results may be substantially unordered, or otherwise arranged in an order that is not based on entity value. The search results identified by the query processor 143 in response to the received search query may then be passed to the ranking engine 160. In some implementations, additional information for each resource may also be passed to ranking engine 160 by location based search engine 140, such as data indicating the amount of time that has elapsed since each resource was last updated, the availability of one or more properties for which the particular resource includes listing information, the interface through which the particular resource's listing information is supplied and/or modified, the value by which one or more properties associated with the listing information of the particular resource exceed the maximum desired value, various verifications associated with the particular resource and properties, or a combination thereof. The location based search engine 140 may communicate with the ranking engine using one or more public or private networks.

System 100 may also include a ranking engine 160. Ranking engine 160 may be hosted by one or multiple server computers. The server computer(s) hosting the ranking engine 160 may be the same server computer(s) that provide the front application server 130. Alternatively, however, the server computer(s) hosting the location based ranking engine 160 may be a different set of one or more server computer(s) that are configured to communicate with the front-end application server 130 via one or more public or private networks.

Ranking engine 160 may be configured to perform a series of post processing operations on the set of identified search results. The post processing operations may determine a ranking score that may be associated with each resource in the set of search resources based at least on the analysis of a metric associated with each entity responsive to a query. For instance, a ranking score may be determined for a particular resource based on the amount of time that has elapsed since the particular resource has been updated, the availability of one or more properties for which the particular resource includes listing information, the interface through which the particular resource's listing information is supplied and/or modified, the value by which one or more properties associated with the listing information of the particular resource exceed the maximum desired value, various verifications associated with the particular resource and properties, or a combination thereof. Ranking engine 160 may utilize make such determinations based on information provided by location based search engine 140, information included in search corpus 150, historical information that is managed or accessed by ranking engine 160, and the like. Ranking engine 160 may then return the set of ordered results to the front-end application server 130 via one or more public or private networks. Front-end application server may then provide the ordered search results to client device 110 via network 120.

Ranking engine 160 may be configured to isolate and analyze search results based on a predetermined geographic region. A geographic region may include, for example, a neighborhood, a city, a state, a zip code, GPS coordinates, longitude and latitude coordinates, a shape drawn by a user on a graphical user interface map, or the like. Once a set of search results are isolated by geographic region, the ranking engine may analyze characteristics each resource and the one or more properties for which each resource includes listing information. For instance, the ranking engine 160 may determine how much time has elapsed since the particular resource was last updated, whether one or more properties for which the particular resource includes listing information are currently available or will become available within an upcoming timeframe, whether the information included in the particular resource is supplied manually through a user interface or automatically through an application programming interface, whether one or more properties for which the particular resource includes listing information have prices that exceed a specified price range, whether any attributes of the particular resource or one or more properties associated with the particular resource, and the like. Ranking engine 160 may utilize make such determinations based on information provided by location based search engine 140, information included in search corpus 150, historical information that is managed or accessed by ranking engine 160, and the like. Ranking engine 160 may assign a score to each resource identified as responsive a given search query.

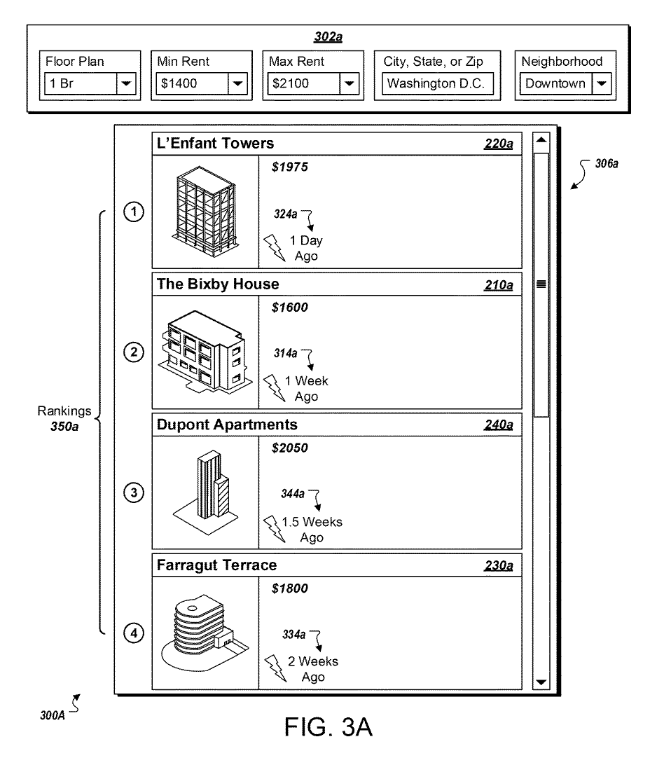

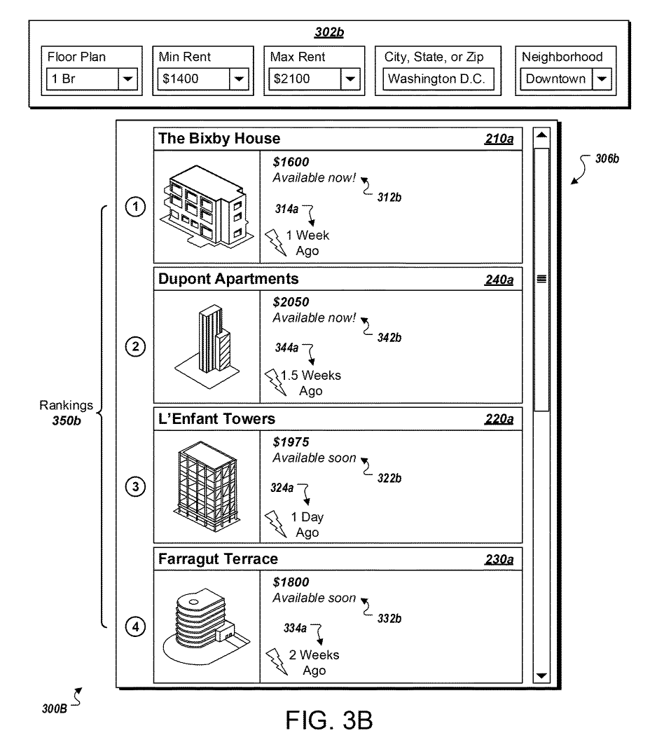

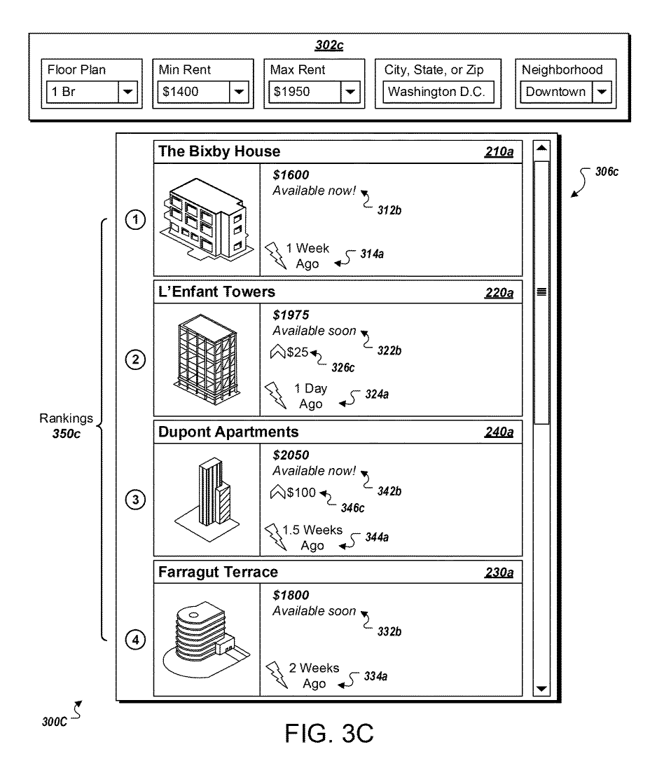

Ranking engine 160 may be configured to make one or more determinations about a particular resource and assign a ranking score based on such determinations, as appropriate. The ranking engine 160 may rank a set of resources based on the ranking score assigned to each resource in the set of resources. In some examples, the ranking engine 160 may, before making one or more of such determinations, determine a ranking score for a particular resource based on default criteria and, after making one or more determinations, adjusting the ranking score for the particular resource based on one or more of such determinations. In some implementations, such ranking scores may be weighted scores, where results of each determination carry a respective weight. For instance, there may be situations in which it is beneficial to assign ranking scores in a manner that favors resources that include information that has been recently updated over resources that include information that has less recently been updated. In this way, users may be presented with listing information that is known to be relatively fresh and up-to-date, which may be especially important in competitive rental markets. As described in more detail below in the discussion of FIG. 3A, the ranking engine 160 may assign rank resources in such a manner by determining the amount of time that has elapsed since each resource has been updated.

In addition, there may be situations in which it is beneficial to assign ranking scores in a manner that favors resources that include listing information for properties that are currently available over resources that only include listing information for properties that are not yet available or listing information for properties with unknown availability. In this way, users may be presented with listing information for properties whose availability is known and temporally-relevant. As described in more detail below in the discussion of FIG. 3B, the ranking engine 160 may assign rank resources in such a manner by determining the availability of the one or more properties associated with each resource.

In a further example, there may be situations in which it is beneficial to assign ranking scores in a manner that favors resources that include listing information for one or more properties that are within a desired price range or exceed the desired price range by a relatively small extent over resources that only include listing information for one or more properties that are not within the desired price range or exceed the desired price by a relatively large extent. In this way, users may be presented with listing information for properties that are within their desired price range, as well as listing information for properties that are just outside of their price range in order to provide users with a better understanding of the types of properties that could be rented at a slightly higher price. This may be a helpful feature for users that are unfamiliar with the rental market they are exploring, as well as users that may have flexible a budget. As described in more detail below in the discussion of FIG. 3C, the ranking engine 160 may assign rank resources in such a manner by determining the value by which one or more properties associated with each resource exceed a specified price range.

In another example, there may be situations in which it is beneficial to assign ranking scores in a manner that favors resources that include listing information for one or more properties with attributes that have been verified by a third party over resources that include listing information for one or more properties with relatively few attributes have been verified by a third party. In this way, users may be presented with listing information for properties with one or more trustworthy characteristics. As described in more detail below in the discussion of FIG. 3D, the ranking engine 160 may assign rank resources in such a manner by determining which third party verifications are associated with the particular resource and properties.

In another aspect, there may be situations in which it is beneficial to assign ranking scores in a manner that favors resources that include listing information that is supplied or modified through a user interface over resources that include listing information that is supplied or modified through an application programming interface. In this way, users may be presented with listing information that is reliably maintained. As described in more detail below in the discussion of FIG. 3D, the ranking engine 160 may assign rank resources in such a manner by determining the interface through which each resource's listing information is supplied and/or modified.

In some aspects of the present disclosure, ranking engine 160 may be utilized only when requested by a user of client device 110. If a user decides to not use ranking engine 160, the search results may be provided to the client device in the order determined by location search engine 140. Such order may be, for example, based on most expensive price, lowest price, based on an analysis of keyword frequency in a web page associated with the search result corresponding to the entity, based on payments received to increase a ranking score associated with each entity, or the like, or any combination thereof. Accordingly, client 110 may be able to toggle ranking engine 160 on and off. In some instances, client 110 may be able to adjust ranking engine 160 such that ranking scores are assigned based on specific characteristics of resources.

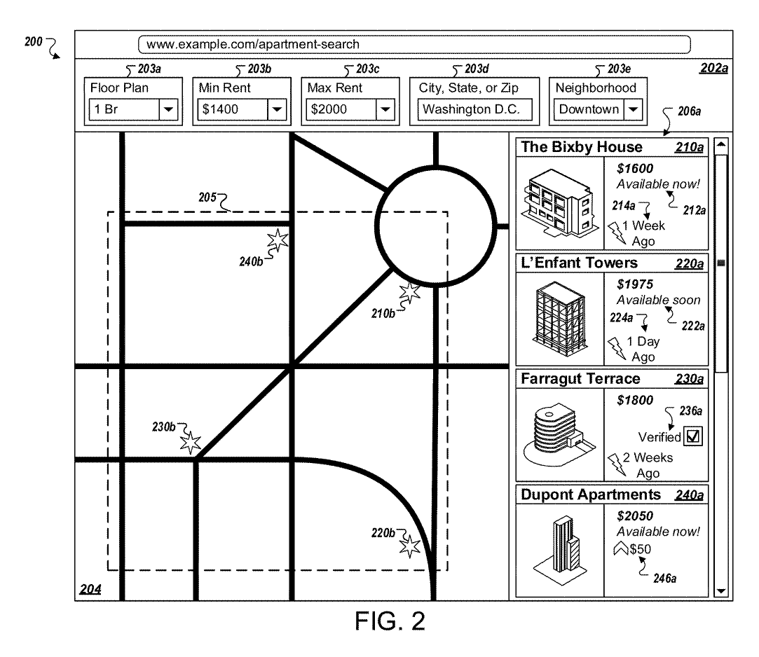

FIG. 2 illustrates an example graphical user interface 200 for displaying a set of search results that include representations of resources identified as responsive to a search query. The graphical user interface 200 may be accessed through a browser or other application running on a personal or mobile computing device, such as browser 113 or application 114 running on client device 110, and may represent a page or screen provided in association with an online real estate marketplace, directory, or search engine. For example, the graphical user interface 200 may represent a webpage of an apartment-finding website showing results returned in response to a user-submitted search query. The graphical user interface 200 may include a search query interface 202a, a map 204, and a listing of search results 206a. Briefly, as described in more detail below, the search query interface 202a may receive one or more search parameters from a user that may be utilized to generate search queries, while the map 204 and listing of search results 206a may present various representations of the search results that are identified responsive to generated search queries.

The search query interface 202a may include a floor plan field 203a that allows user to specify a desired floor plan, a minimum rent field 203b that allows user to specify a minimum desired rental price, a maximum rent field 203c that allows users to specify a maximum desired rental price, a general location field 203d that allows users to specify a desired geographic region on a city, state, or zip-code scale, and a neighborhood field 203e that allows users to specify a desired geographic region on a neighborhood scale. In some examples, the search query interface 202a may include additional drop-down menus and other fields that receive open-ended textual input, data indicating one or more user preferences or selections, or a combination thereof.

In the example of FIG. 2, a user has provided input to search query interface 202a that corresponds to a one bedroom floor plan, a minimum desired rental price of $1400 per month, a maximum desired rental price of $2000 per month, and a desired geographic region of the “Downtown” neighborhood of Washington, D.C. The application running on client device may generate a query based on the search parameters or criteria received through the search query interface 202a, forward the query to front-end application server 130, and the search query may be executed by one or more back-end components of system 100 such as, location search engine 140. Alternatively, any unstructured search criteria entered by a user via graphical user interface 200A may be transmitted to front-end application server 130, front-end application server 130 may then generate a search query based on the received search criteria, and then the search query may be executed by one or more back-end components of system 100 such as, location search engine 140. Then search results such as, for example, resources that include listing information for the apartments shown on map 204 and within listing 206a may be returned to client device 110, and presented through graphical user interface 200.

Representations of the initial set of search results may be displayed as a list of search results 206a that may include, for example, a representation 210a of a listing for the Bixby House, a representation 220a of a listing for L'Enfant Towers, a representation 230a of a listing for Farragut Terrace, and a representation 240a of a listing for Dupont Apartments. That is, representations 210a-240a correspond to listings for one or more properties within the Bixby House, L'Enfant Towers, Farragut Terrace, and Dupont Apartments communities, respectively, each of which may represent search results returned in response to a search query generated based on information provided to search query interface 202a for rental property listings within the “Downtown” geographic region of the District of Columbia. In some implementations, representations of search results, such as resources, may be presented within list of search results 206a in an order that corresponds to rankings of the search results, such as those provided at least in part by ranking engine 160. Representations 210a-240a as shown in FIG. 2 are not, however, arranged in list of search results 206a according to any particular order or ranking. That is, the depicted state of graphical user interface 200 is an example of the graphical user interface that may appear when the ranking engine 160 has been toggled off. Each representation included in the list of search results 206a may, for instance, include an image of the respective rental property, a textual overview of the details of the listing, one or more graphical or textual elements that indicate characteristics of the respective rental property or the resource that includes listing information for the respective property, and the like.

For instance, representation 210a may include text indicating the name of the community to which one or more rental properties belongs, or “The Bixby House,” an image of the Bixby House community from an aerial perspective, and text indicating the monthly rental fee of the one or more properties, or $1600. In addition, each representation may also include one or more indications of characteristics of the respective community, individual properties within the respective community, and the resource that includes listing information for one or more properties within the respective community. In some examples, each of representations 210a-240a may include one or more graphical or textual elements that indicate the amount of time that has elapsed since the corresponding resource has been updated, e.g., quantity of hours, days, or weeks since the web page that includes listing information was last updated, the availability of one or more properties within the respective community, e.g., whether properties are available now or will be available in the near future, the interface through which the corresponding resource's listing information is supplied and/or modified, e.g., application programming interface, user interface, etc., the amount by which one or more properties within the respective community exceed the maximum desired rental price specified, various verifications associated with the corresponding resource and properties, e.g., third party verification of features of properties, owners or managers of the community or properties, building certifications, etc., or a combination thereof. Such elements may be generated based on information that is utilized to make one or more of the determinations about resources, such as those which are used for assigning ranking scores as described above in reference in reference to FIG. 1. For example, representations 210a-240a are shown as including some of such graphical and/or textual elements.

In the example of FIG. 2, representation 210a includes an element 212a indicating that one or more apartments in the Bixby House community are currently available for tenancy and element 214a indicating that the web page that includes the listing information for the Bixby House was last updated a week ago. Similarly, representation 220a includes elements 222a and 224a indicating that one or more apartments in L'Enfant Towers will become available soon and that the web page that includes the listing information for L'Enfant Towers was last updated one day ago, respectively. It can be seen that representation 230a includes an element 236a indicating that one or more attributes of Farragut Terrace have been verified by a third party. In addition, representation 240a as provided in the example of FIG. 2 includes an element 246a indicating that one or more units in the Dupont Apartments communities exceed the desired price range received by search interface 202a by $50. It is to be understood that search result representations provided by the techniques described herein may each include some or all of the types of elements described above. In some implementations, search result representations may only include elements that indicate information that is known to the search engine system 100.

In addition, one or more portions of each representation may serve as hyperlinks that point to other resources associated with the respective rental property listing. Representations 210a-240a may further include one or more hyperlinks or other interactive components that direct users to a resource that includes the corresponding listing information, or other information related to the particular units or properties available for tenancy, the communities, the area surrounding the location of the particular units available for tenancy, and the like.

Alternatively, or in addition, the search results may be represented on map 204 of the geographic location associated with the apartments. In some implementations, the map 204 may include a graphical icon associated with the geographic location of each identified search result. For instance, the map 204 may show topographical information for Washington, D.C., and more specifically the Downtown neighborhood 205 of Washington, D.C., and further provides a graphical icon 210b that represents the listing for the Bixby House, a graphical icon 220b that represents the listing for L'Enfant Towers, a graphical icon 230b that represents the listing for Farragut Terrace, and a graphical icon 240b that represents the listing for Dupont Apartments. In some examples, graphical icons 210b-240b may be interactive elements that point to each of representations 210a-240a, respectively, or to each of the resources to which representations 210a-240a correspond, respectively.

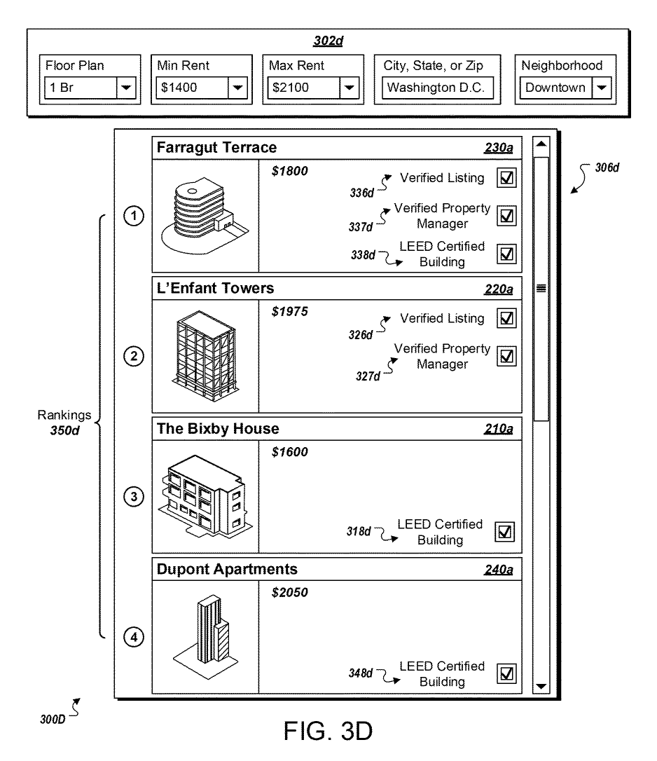

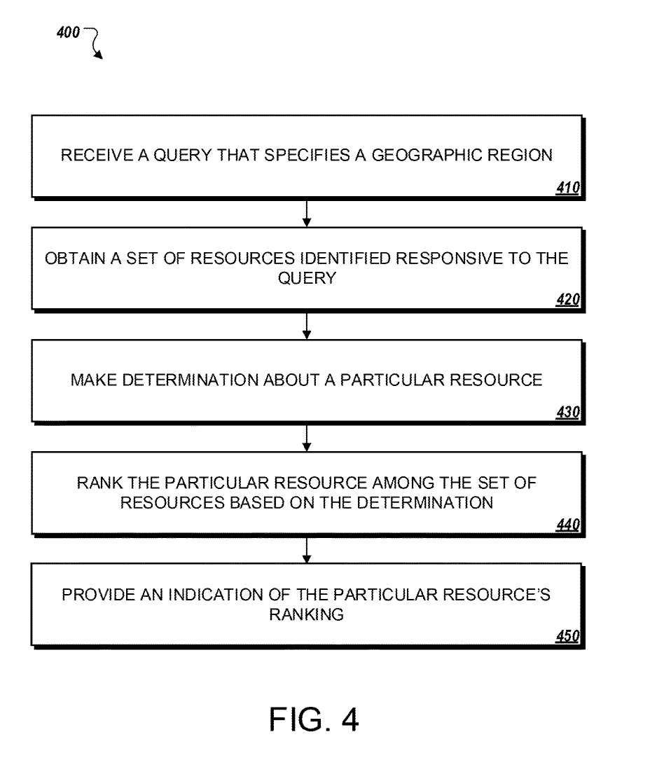

In some examples, representations of resources that are identified as responsive to search queries may be presented within list of search results 206a according their respective rankings. Each resource that is identified as responsive to a search query may, for instance, be ranked among the set of identified resources according to the ranking score provided by ranking engine 160 based on one or more determinations about the respective resource. Examples of the impact that such determinations may have on the rankings of resources that are identified as responsive to search queries are described in more detail below in reference to FIGS. 3A-3D and 4. In some implementations, such ranking scores may be weighted scores, where results of each determination carry a respective weight.

FIG. 3A illustrates an example graphical user interface 300A for displaying a set of search results that include representations of resources that are ranked by amount of time having elapsed since each resource was last updated. The graphical user interface 300A may be similar to at least a portion of the graphical user interface 200 as described above, and may at least include a search query interface 302a, a map (not shown), and a listing of search results 206a. Briefly, as described in more detail below, the search query interface 302a may receive one or more search parameters from a user that may be utilized to generate search queries, while the listing of search results 306a presents representations 210a-240a of the search results that are identified responsive to generated search queries as ranked according to rankings 350a, or by amount of time having elapsed since each resource was last updated.

In the example of FIG. 3A, a user has provided input to search query interface 302a that corresponds to a one bedroom floor plan, a minimum desired rental price of $1400 per month, a maximum desired rental price of $2100 per month, and a desired geographic region of the “Downtown” neighborhood of Washington, D.C. Representations of the initial set of search results obtained in response to the input provided to search query interface 302a may correspond or be similar to representations 210a-240a as described above with reference to FIG. 2, and may be displayed as a list of search results 306a in an order that corresponds to rankings 350a. The example depicted in FIG. 3A shows representations 210a-240a as ranked entirely or largely on the basis of the amount of time having elapsed since each corresponding resource was last updated. That is, the ranking scores that are assigned to the search results of FIG. 3A may place disproportionate weight on such amounts of elapsed time.

As shown in FIG. 3A, the rankings 350a of list of search results 306a correspond to representation 220a of the listing for L'Enfant Towers being ranked first, representation 210a of the listing for the Bixby House being ranked second, representation 240a of a listing for Dupont Apartments being ranked third, and representation 230a of the listing for Farragut Terrace being ranked fourth. In this example, the ranking engine 160 may have, for instance, determined that the web page that includes information for L'Enfant Towers was the most recently updated resource identified as responsive to the search query generated based on the input provided to search query interface 302a, followed by the resources that include information for the Bixby House, Dupont Apartments, and Farragut Terrace, respectively. It can be seen that, in this example, the ranking engine 160 may has assigned ranking scores in a manner that favors resources that include information that has been recently updated over resources that include information that has less recently been updated. In this way, users may be more quickly connected with relevant listing information, and may spend less time browsing or following up on outdated property listings.

In some examples, representations 210a-240a may further include elements 314a-344a, respectively, that indicate the amount of time having elapsed since each represented resource was last updated. Each of elements 314a-344a may also be generated on determinations made by ranking engine 160. For instance, ranking engine 160 may have determined that the web page that includes information for L'Enfant Towers was updated one day ago, that the web page that includes information for the Bixby House was updated one week ago, that the web page that includes information for Dupont Apartments was updated one and a half weeks ago, and that the web page that includes information for Farragut Terrace was updated two weeks ago. In some implementations, the difference between the time at which a search query is generated from input provided to search query interface 302a and the time at which each resource was last updated is utilized as the amount of elapsed time that is relied upon to rank results and generate the textual and/or graphical elements that are presented with the representation of each result.

FIG. 3B illustrates an example graphical user interface 300B for displaying a set of search results that include representations of resources that are ranked by property availability. The graphical user interface 300B may be similar to at least a portion of the graphical user interface 300A as described above, and may at least include a search query interface 302b, a map (not shown), and a listing of search results 206b. Briefly, as described in more detail below, the search query interface 302b may receive one or more search parameters from a user that may be utilized to generate search queries, while the listing of search results 306b presents representations 210a-240a of the search results that are identified responsive to generated search queries as ranked according to rankings 350b, or by property availability.

In the example of FIG. 3B, a user has provided input to search query interface 302b that corresponds to a one bedroom floor plan, a minimum desired rental price of $1400 per month, a maximum desired rental price of $2100 per month, and a desired geographic region of the “Downtown” neighborhood of Washington, D.C. Representations of the initial set of search results obtained in response to the input provided to search query interface 302b may correspond or be similar to representations 210a-240a as described above with reference to FIG. 2, and may be displayed as a list of search results 306b in an order that corresponds to rankings 350b. The example depicted in FIG. 3B shows representations 210a-240a as ranked largely on the basis of property availability.

As shown in FIG. 3B, the rankings 350b of list of search results 306b correspond to representation 210a of the listing for the Bixby House being ranked first, representation 240a of a listing for Dupont Apartments being ranked second, representation 220a of the listing for L'Enfant Towers being ranked third, and representation 230a of the listing for Farragut Terrace being ranked fourth. In this example, the ranking engine 160 may have, for instance, determined that one or more apartments within the Bixby House and Dupont Apartments are currently available, and that one or more apartments within L'Enfant Towers and Farragut Terrace will become available soon. It can be seen that, in this example, the ranking engine 160 may has assigned ranking scores in a manner that favors resources that include listing information for properties that are currently available over resources that only include listing information for properties that are not yet available or listing information for properties with unknown availability. By providing search results in this manner, users may spend less time browsing or following up on listings for properties that are not available within a relevant timeframe. For this reason, rankings 350b can be seen as favoring search results corresponding to the Bixby House and Dupont Apartments over those corresponding to L'Enfant Towers and Farragut Terrace. In addition, the rankings 350b may further favor search results corresponding to the Bixby House over those corresponding to Dupont Apartments on the basis of a secondary consideration, such as the amount of time having elapsed since the web page that includes information for the Bixby House being less than that of the web page that includes information for Dupont Apartments. Similarly, the rankings 350b may also favor search results corresponding to L'Enfant Towers over those corresponding to Farragut Terrace on the basis of the amount of time having elapsed since the web page that includes information for L'Enfant Towers being less than that of the web page that includes information for Farragut Terrace. That is, the ranking scores that are assigned to the search results of FIG. 3B may place weight on both property availability and amount of time elapsed since last update, with more weight being placed on property availability. In this way, the amount of time elapsed since last update can be seen as a tie-breaker in this example.

In some implementations, a level of membership of users that manage such resources may be taken into account when evaluating property availability or ranking one or more resources on the basis of property availability. For example, the ranking engine 160 may boost ranking scores that are assigned to resources that include information for one or more properties that are not currently available, will not become available in the near future, or whose availability is unknown, as long as such information is managed at least in part by one or more users of a sponsored account. In this way, paying members of an apartment-finding website or service that provides graphical user interface 300B may receive the added benefit of having the listing information that they manage be returned irrespective of the availability of the properties at hand.

In some examples, representations 210a-240a may further include elements 312b-342b, respectively, that indicate the availability of one or more properties associated with each resource. Each of elements 312b-342b may also be generated on determinations made by ranking engine 160. In some implementations, the difference between the time at which a search query is generated from input provided to search query interface 302b and property availability dates indicated in listing information is utilized to determine property availability conditions that are relied upon to rank results and generate the textual and/or graphical elements that are presented with the representation of each result. Data indicating such property availability may be managed by or accessible to the ranking engine 160 or other components of system 100.

FIG. 3C illustrates an example graphical user interface 300C for displaying a set of search results that include representations of resources that are ranked at least in part by property price with respect to a desired price range. The graphical user interface 300C may be similar to at least a portion of the graphical user interfaces 300A-B as described above, and may at least include a search query interface 302c, a map (not shown), and a listing of search results 206c. Briefly, as described in more detail below, the search query interface 302c may receive one or more search parameters from a user that may be utilized to generate search queries, while the listing of search results 306c presents representations 210a-240a of the search results that are identified responsive to generated search queries as ranked according to rankings 350c, or by property price with respect to a desired price range.

In the example of FIG. 3C, a user has provided input to search query interface 302c that corresponds to a one bedroom floor plan, a minimum desired rental price of $1400 per month, a maximum desired rental price of $1950 per month, and a desired geographic region of the “Downtown” neighborhood of Washington, D.C. Representations of the initial set of search results obtained in response to the input provided to search query interface 302c may correspond or be similar to representations 210a-240a as described above with reference to FIG. 2, and may be displayed as a list of search results 306c in an order that corresponds to rankings 350c.

In some implementations, the initial set of search results may be obtained in response to a subset of the input provided to search query interface 302c. For instance, the set of resources identified as responsive to the search query generated in association with search query interface 302c may each include listing information for one or more properties located in the “Downtown” neighborhood of Washington, D.C., but such properties may not necessary fall within the specified price range of $1400 to $1950 per month. That is, the initial set of search results may be obtained irrespective of the minimum and maximum desired rental prices that have been specified, in this example, by the user of search query interface 302c. In such implementations, the location based search engine 140 may identify resources that include listing information for properties whose prices fall within the specified price range of $1400 to $1950 per month, as well as resources that include listing information for properties whose prices exceed the specified price range of $1400 to $1950 per month by less than a predetermined amount. Additionally or alternatively, the location based search engine 140 may identify resources that include listing information for properties whose prices fall outside of the specified price range of $1400 to $1950 per month, and the ranking engine 160 may prune back the set of search results provided by location based search engine 140 to exclude resources that include listing information for properties whose prices exceed the specified price range of $1400 to $1950 per month by more than the predetermined amount, or the ranking engine 160 may simply assign relatively low ranking scores to resources that include listing information for properties whose prices exceed the specified price range of $1400 to $1950 per month by more than the predetermined amount. In some examples, the predetermined amount may user-defined. Additionally or alternatively, the predetermined amount may correspond to a predetermined percentage of the specified price range.

The rankings 350c of search results 306c can be seen as being similar to that of the rankings 350b of search results 306b, as described above in reference to FIG. 3B. That is, the ranking scores that are assigned to the search results of FIG. 3C may place weight on both property availability and amount of time elapsed since last update, with more weight being placed on property availability, and may at least partially place weight on property price with respect to a desired price range. For resources that include listing information for properties whose prices exceed a desired price range by less than the predetermined amount, the amount of weight placed on property price with respect to a desired price range may, in some examples, be inversely proportional to the extent to which such prices exceed the desired price range. In this way, users may be presented with properties that are just slightly beyond their specified price range, which may allow users to gain greater perspective of the real estate market they are exploring and reevaluate their budgets.

As shown in FIG. 3C, the rankings 350c of list of search results 306c correspond to representation 210a of the listing for the Bixby House being ranked first, representation 220a of the listing for L'Enfant Towers being ranked second, representation 240a of a listing for Dupont Apartments being ranked third, and representation 230a of the listing for Farragut Terrace being ranked fourth. It can be noted that, with the exception of representation 220a of the listing for L'Enfant Towers being ranked second and representation 240a of a listing for Dupont Apartments being ranked third, the rankings 350c of search results 306c are substantially the same as that of the rankings 350b of search results 306b, as described above in reference to FIG. 3B. In this example, the ranking engine 160 may have, for instance, determined that one or more apartments within the Bixby House have prices that fall within the specified price range of $1400 to $1950 per month, that one or more one or more apartments within L'Enfant Towers have prices that exceed the specified price range of $1400 to $1950 per month by $25 per month, that one or more apartments in the Dupont Apartment community have prices that exceed the specified price range of $1400 to $1950 per month by $100 per month, and that one or more apartments within Farragut Terrace have prices that fall within the specified price range of $1400 to $1950 per month. It can be seen that, in this example, the ranking engine 160 may have assigned ranking scores in a manner that favors resources that include listing information for one or more properties that are within a desired price range or exceed the desired price range by a relatively small extent over resources that only include listing information for one or more properties that are not within the desired price range or exceed the desired price by a relatively large extent. For this reason, rankings 350c can be seen as favoring search results corresponding to L'Enfant Towers over those corresponding to Dupont Apartments, such that rankings 350c of search results 306c differ from rankings 350b of search results 306b.

For instance, rankings 350c may favor search results corresponding to the Bixby House over those of L'Enfant Towers, Dupont Apartments, and Farragut Terrace at least in part because it was determined that the web page for the Bixby House was updated relatively recently and includes listing information for one or more apartments are currently available and have prices that fall within the specified price range of $1400 to $1950 per month. Furthermore, rankings 350c may favor search results corresponding to L'Enfant Towers over those of Dupont Apartments because the extent to which prices of apartments within the Dupont Apartment community exceed the desired price range, or $100 per month, may have more of an adverse impact on ranking score than the extent to which prices of apartments within L'Enfant Towers exceed the desired price range, or $25 per month, does. Lastly, rankings 350c may favor search results corresponding to Dupont Apartments over those of Farragut Terrace because the adverse impact that the prices of apartments in the Dupont Apartment community may not have been enough to negate the advantages in property availability and amount of time elapsed since last update that Dupont Apartments has over Farragut Terrace.

In some examples, representations 220a and 240a may further include elements 326c and 346c that indicate that one or more properties associated with the resources that correspond to representations 220a and 240a, respectively, have prices that exceed the maximum desired rent that has been provided as input to search query interface 302c, and the extent to which such prices exceed the maximum desired rent. Each of elements 326c and 346c may also be generated on determinations made by ranking engine 160. In some implementations, the difference between the maximum desired rent price that is provided as input to search query interface 302c and the price of one or more properties indicated in listing information is utilized to determine the pricing conditions that are relied upon to rank results and generate the textual and/or graphical elements that are presented with the representation of each result.

FIG. 3D illustrates an example graphical user interface 300D for displaying a set of search results that include representations of resources that are ranked by property verifications. The graphical user interface 300D may be similar to at least a portion of the graphical user interfaces 300A-C as described above, and may at least include a search query interface 302d, a map (not shown), and a listing of search results 206d. Briefly, as described in more detail below, the search query interface 302d may receive one or more search parameters from a user that may be utilized to generate search queries, while the listing of search results 306d presents representations 210a-240a of the search results that are identified responsive to generated search queries as ranked according to rankings 350d, or by property verifications.

In the example of FIG. 3D, a user has provided input to search query interface 302c that corresponds to a one bedroom floor plan, a minimum desired rental price of $1400 per month, a maximum desired rental price of $2100 per month, and a desired geographic region of the “Downtown” neighborhood of Washington, D.C. Representations of the initial set of search results obtained in response to the input provided to search query interface 302d may correspond or be similar to representations 210a-240a as described above with reference to FIG. 2, and may be displayed as a list of search results 306c in an order that corresponds to rankings 350d. The example depicted in FIG. 3D shows representations 210a-240a as ranked largely on the basis of quantity and/or type of property verifications. That is, the ranking scores that are assigned to the search results of FIG. 3D may place disproportionate weight on such quantity and/or type of property verifications.

As shown in FIG. 3D, the rankings 350d of list of search results 306d correspond to representation 230a of the listing for Farragut Terrace being ranked first, representation 220a of the listing for L'Enfant Towers being ranked second, representation 210a of the listing for the Bixby House being ranked third, and representation 240a of a listing for Dupont Apartments being ranked fourth. In this example, the ranking engine 160 may have, for instance, determined that the listing information provided in association with Farragut Terrace has been verified by a third party verification service, that the owner or manager of Farragut Terrace has passed a background check administered by a third party verification service, and further that Farragut Terrace is verified by a third party verification service as being a Leadership in Energy and Environmental Design (“LEED”) certified building. For instance, the listing information provided in association with Farragut Terrace has been verified by a third party verification service to indicate that features and/or amenities that are described as being part of or included in apartments within Farragut Terrace are accurate. In some examples, such a third party verification service may visit Farragut Terrace to confirm that the listing information provides an accurate representation of Farragut Terrace and its units.

In addition, the ranking engine 160 may have, for instance, determined that the listing information provided in association with L'Enfant Towers has also been verified by a third party verification service and that the owner or manager of L'Enfant Towers has passed a background check administered by a third party, and that the Bixby House Dupont Apartment buildings are LEED certified. It can be seen that, in this example, the ranking engine 160 may has assigned ranking scores in a manner that favors resources that include listing information for one or more properties with attributes that have been verified by a third party over resources that include listing information for one or more properties with relatively few attributes have been verified by a third party. For this reason, rankings 350d can be seen as favoring search results corresponding to Farragut Terrace over those corresponding to L'Enfant Towers, the Bixby House, and Dupont Apartments.

In addition, the rankings 350d may further favor search results corresponding to the Bixby House over those corresponding to Dupont Apartments on the basis of a secondary consideration. For instance, the rankings 350d may favor the Bixby House over Dupont Apartments because ranking engine 160 may have determined that listing information included in the Bixby House web page is supplied or modified through a user interface, and further determined that listing information included in the Dupont Apartments web page is supplied or modified through an application programming interface. That is, the ranking scores that are assigned to the search results of FIG. 3D may place weight on both quantity and/or type of property verifications and type of interface through which listing information is supplied and/or provided, with more weight being placed on quantity and/or type of property verifications. In this way, the type of interface through which listing information is supplied and/or provided can be seen as a tie-breaker in this example. It is, however, to be understood that, in some examples, representations 210a-240a as ranked largely or entirely on the basis of the type of interface through which listing information is supplied and/or provided. By providing search results in this manner, users may be able to spend less time browsing or following up on property listings that include information that is unreliable, provided by untrusted sources, or both.

In some examples, representations 210a-240a may further include elements 336d-348d, respectively, that indicate various verifications of one or more properties associated with each resource. Each of elements 336d-348d may also be generated on determinations made by ranking engine 160. In some implementations, an entity or service that is at least in part responsible for providing graphical user interface 300D may serve as one or more of the third parties that verify attributes of properties. For instance, such attributes may include features of properties, amenities of properties, authenticity of listing information, environmental or structural characteristics of properties, certifications and licensure held by one or more entities associated with properties, and the like. Data indicating such attributes, along with any corresponding verifications may be provided, modified, and managed by one or more third party verification services that communicate with the resource management console 170, and may be accessible to or further managed by the ranking engine 160 or other components of system 100.

In some examples, the ranking engine 160 may determine whether each resource includes information that is supplied or modified through a user interface or an application programming interface based on analysis that is performed on data included in search corpus 150. In some instances, such a determination may be made based on monitoring one or more administrative tools, such as those provided by the resource management console 170, and allow members or account holders, such as realtors and property managers, to supply and/or modify to one or more resources. In this way, the ranking engine 160 may determine, based on monitoring of such administrative tools, whether information included in various resources is being supplied and/or modified by corresponding members through a user interface or other interface that receives manual input from users, or an application programming interface or other interface that automatically receives input from one or more computing modules in an automated manner. Data indicating the listing information interface associated with each resource may be managed by or accessible to the ranking engine 160 or other components of system 100.

FIG. 4 illustrates exemplary process 400 for enhancing point of interest identification. The following describes the process 400 as being performed by components of system 100 described above with reference to FIG. 1 and in association with one or more components described above with reference to FIGS. 2-3D. However, the process 400 may be performed by other systems or system configurations. Briefly, the process 400 may include receiving a query that specifies a geographic region (410), obtaining a obtaining a set of resources that (i) are identified as responsive to the query and (ii) each include listing information for one or more properties located within the geographic region (420), making one or more determinations about a particular resource among the set of resources (430), ranking the particular resource among the set of resources based at least on the one or more determinations (440), and providing an indication of the particular resource's ranking among the set of resources (450).

In more detail, process 400 may include receiving a query that specifies a geographic region (410). For example, this may correspond to receiving a search query that corresponds to input that is provided to search query interface 202a, such as input that is provided to general location field 203d and/or neighborhood field 203e.

The process 400 may include obtaining a obtaining a set of resources that (i) are identified as responsive to the query and (ii) each include listing information for one or more properties located within the geographic region (420). For example, this may correspond to obtaining a set of resources, such as those which correspond to representations 210a-240a, that are each identified as responsive to a search query that corresponds to at least a portion of the input that is provided to search query interface 202a and include listing information for one or more properties located within the geographic region, such as listing information for apartments within the Bixby House, L'Enfant Towers, Farragut Terrace, and Dupont Apartments, each of which are located within geographic region 205.

The process 400 may include making one or more determinations about a particular resource among the set of resources (430). This may, for instance, correspond to the ranking engine 160 making one or more of the determinations that are used for providing rankings 350a-350d, as described above in reference to FIGS. 3A-3D, respectively. For example, one or more determinations may be made about a particular resource regarding the amount of time that has elapsed since particular resource was last updated, the availability of one or more properties for which the particular resource includes listing information, the interface through which the particular resource's listing information is supplied and/or modified, the value by which one or more properties associated with the listing information of the particular resource exceed the maximum desired value, various verifications associated with the particular resource and properties, or a combination thereof.

The process 400 may include ranking the particular resource among the set of resources based at least on the one or more determinations (440). This may, for instance, correspond to the ranking engine 160 providing rankings 350a-350d, as described above in reference to FIGS. 3A-3D, respectively, based on one or more determinations. For example, the set of resources may be ranked based on one or more determinations may be made about a particular resource regarding the amount of time that has elapsed since particular resource was last updated, the availability of one or more properties for which the particular resource includes listing information, the interface through which the particular resource's listing information is supplied and/or modified, the value by which one or more properties associated with the listing information of the particular resource exceed the maximum desired value, various verifications associated with the particular resource and properties, or a combination thereof.

The process 400 may include providing an indication of the particular resource's ranking among the set of resources (450). For example, this may correspond to presenting search results or representations of resources in an order similar to that which has been described above in reference to rankings 350a-350d.

In some implementations, making one or more determinations about a particular resource among the set of resources may include determining that a particular resource among the set of resources includes listing information that was last updated within a predetermined amount of time. The predetermined amount of time may, for instance, be defined by one or more users or administrators of system 100, and may additionally be adjusted over time or for specific search queries. In these implementations, ranking the particular resource among the set of resources based at least on the one or more determinations may include ranking the particular resource among the set of resources based at least on determining that the particular resource among the set of resources includes listing information that was last updated within a predetermined amount of time. For instance, this may correspond to determining that a particular resource described in association with FIG. 3A, such as those corresponding to any of representations 220a-240a, includes listing information that was last updated within a predetermined amount of time, and ranking the particular resource according to rankings 350a, or by amount of time having elapsed since each resource was last updated.

In such implementations, the process 400 may further include generating one or more representations of the particular resource, at least one of which indicates that the particular amount of time has elapsed since the particular resource was last updated. In such examples, providing the indication of the particular resource's ranking among the set of resources may include providing the one or more representations of the particular resource, with indication of the particular resource's ranking among the set of resources, for output. For instance, this may correspond to generating any of representations 210a-240a described in association with FIG. 3A that include elements 314a-344a, respectively, that indicate the amount of time having elapsed since each represented resource was last updated. The process 400 may, in some of these examples, further include determining that the particular resource includes listing information for one or more properties that reside at a particular location within the geographic region. In these examples, generating one or more representations of the particular resource may include generating one or more representations of the particular resource, at least one of which indicates the particular location within the geographic region. For instance, this may correspond to generating any of graphical icons 210b-240b that are depicted within geographical region 205 on the map 204 as provided by the graphical user interface 200 as described above in association with FIG. 2.

In some implementations, making one or more determinations about a particular resource among the set of resources may include determining whether a particular resource among the set of resources includes listing information for one or more properties that are indicated as available for occupancy at a particular point in time. In these implementations, ranking the particular resource among the set of resources based at least on the one or more determinations may include ranking the particular resource among the set of resources based at least on determining whether the particular resource among the set of resources includes listing information for one or more properties that are indicated as available for occupancy at the particular point in time. For instance, this may correspond to determining that a particular resource described in association with FIG. 3B, such as those corresponding to any of representations 220a-240a, includes listing information for one or more properties that are currently available or will become available soon, and ranking the particular resource according to rankings 350b, or property availability.

In such implementations, determining whether the particular resource among the set of resources includes listing information for one or more properties that are indicated as available for occupancy at the particular point in time may, in some implementations, include determining whether the particular resource among the set of resources includes listing information for one or more properties that are indicated as currently available for occupancy. In some examples, receiving the query that specifies the geographic region may include receiving, at a first point in time, a query that specifies a geographic region. In such examples, determining whether the particular resource among the set of resources includes listing information for one or more properties that are indicated as available for occupancy at the particular point in time may include determining whether the particular resource among the set of resources includes listing information for one or more properties that are indicated as becoming available for occupancy within a particular amount of time after the first point in time. In some implementations, the process 400 may further include determining whether the particular resource among the set of resources includes listing information that is managed at least in part by one or more users of a sponsored account. In such implementations, ranking the particular resource among the set of resources may, for instance, include ranking the particular resource among the set of resources based further on determining whether the particular resource among the set of resources includes listing information that is managed at least in part by one or more users of a sponsored account. This may, for instance, correspond to the example described above in association with FIG. 3B in which the ranking engine 160 may boost ranking scores that are assigned to resources that include information for one or more properties that are not currently available, will not become available in the near future, or whose availability is unknown, as long as such information is managed at least in part by one or more users of a sponsored account.

In some implementations, making one or more determinations about a particular resource among the set of resources may include determining that a particular resource among the set of resources includes listing information that was supplied through a particular listing information interface. In these implementations, ranking the particular resource among the set of resources based at least on the one or more determinations may include ranking the particular resource among the set of resources based at least on determining that the particular resource among the set of resources includes listing information that was supplied through the particular listing information interface. For instance, this may correspond to determining that a particular resource described in association with FIG. 3D, such as those corresponding to any of representations 220a-240a, includes listing information for one or more properties that having been supplied or modified through a given interface, and ranking the particular resource according to rankings 350d, or by listing information interface.

In such implementations, determining that the particular resource among the set of resources includes listing information that was supplied through the particular listing information interface may, in some examples, include determining that the particular resource among the set of resources includes listing information that was supplied through a user interface. In addition, determining that the particular resource among the set of resources includes listing information that was supplied through the particular listing information interface may, in some instances, include determining that the particular resource among the set of resources includes listing information that was supplied through an application programming interface. For instance, this may correspond to the example described in association with FIG. 3D in which rankings 350d favor search results corresponding to the Bixby House over those corresponding to Dupont Apartments, on the basis of the web page for the Bixby House including listing information that is supplied and/or modified through a user interface and the web page for Dupont Apartments including listing information that is supplied and/or modified through an application programming interface.

In some examples, the process 400 may further include further include determining that the particular resource includes listing information for one or more properties that reside at a particular location within the geographic region and generating one or more representations of the particular resource, at least one of which indicates the particular location within the geographic region. In such examples, providing the indication of the particular resource's ranking among the set of resources may include providing the one or more representations of the particular resource, with indication of the particular resource's ranking among the set of resources, for output. This may, for instance, correspond to generating and outputting any of the representations or graphical icons described herein in a manner that indicates respective rank. In the example of FIG. 3D, this may correspond to providing search results 306d for output at graphical user interface 300D in an order that corresponds to the rankings 350d.

In some implementations, making one or more determinations about a particular resource among the set of resources may include determining that a particular resource among the set of resources includes listing information for one or more properties having prices that exceed the price range by a particular amount. In these implementations, ranking the particular resource among the set of resources based at least on the one or more determinations may include ranking the particular resource among the set of resources based at least on determining that the particular resource among the set of resources includes listing information for one or more properties having prices that exceed the price range by the particular amount. For instance, this may correspond to determining that a particular resource described in association with FIG. 3C, such as those corresponding to any of representations 220a-240a, includes listing information for one or more properties having prices that fall within a price range specified by search query interface 302d or exceed the price range specified by search query interface 302c by a particular amount, and ranking the particular resource according to rankings 350c, or at least in part by property price with respect to a desired price range.

In some examples, receiving the query that specifies the geographic region and the price range may, in some implementations, include receiving a query that specifies a geographic region and a price range that extends from a lower limit to an upper limit. This may, for instance, correspond to the price range described in association with FIG. 3C that extends from a lower limit of $1400 per month to an upper limit of $1950 per month, as indicated by input that is received through search query interface 302d. In such implementations, the process 400 may further include determining, based at least on the received price range, a particular price range that (i) is different from the received price range and (ii) extends from the upper limit of the received price range to another limit that exceeds the upper limit of the price range. In some implementations, determining that the particular resource among the set of resources includes listing information for one or more properties having prices that exceed the price range by the particular amount may, in some instances, include determining that the particular resource among the set of resources includes listing information for one or more properties having prices that fall within the particular price range. For instance, this may correspond to determining a particular price range that extends from the maximum rent price of $1950 per month to another limit that exceeds the maximum rent price of $1950 per month, and also exceeds rent prices of $1975 and $2050 per month, such that properties within L'Enfant Towers and Dupont Apartments have prices that fall within the particular price range. In some examples, the process 400 may further include generating one or more representations of the particular resource, at least one of which indicates that the particular resource includes listing information for one or more properties having prices that fall within the particular price range. In such implementations, providing the indication of the particular resource's ranking among the set of resources may include providing the one or more representations of the particular resource, with indication of the particular resource's ranking among the set of resources, for output. For instance, this may correspond to generating any of representations 220a and 240a described in association with FIG. 3C that include elements 326c and 346c, respectively, that indicate that one or more properties associated with the resources that correspond to representations 220a and 240a, respectively, have prices that exceed the maximum desired rent that has been provided as input to search query interface 302c, and the extent to which such prices exceed the maximum desired rent.

In some implementations, making one or more determinations about a particular resource among the set of resources may include determining that a particular resource among the set of resources includes listing information for one or more properties that have a particular attribute that has been indicated as verified by a third party listing information verification service. In these implementations, ranking the particular resource among the set of resources based at least on the one or more determinations may include ranking the particular resource among the set of resources based at least on determining that the particular resource among the set of resources includes listing information for one or more properties that have the particular attribute that has been indicated as verified by the third party listing information verification service. For instance, this may correspond to determining that a particular resource described in association with FIG. 3D, such as those corresponding to any of representations 220a-240a, includes listing information for one or more properties having attributes that have been verified, and ranking the particular resource according to rankings 350d, or by quantity and/or type of property verifications.

In some examples, determining that the particular resource among the set of resources includes listing information for one or more properties that have the particular attribute that has been indicated as verified by the third party listing information verification service may, in some implementations, include determining that the particular resource among the set of resources includes listing information for one or more properties that has been indicated by the third party listing information verification service as being owned or managed by an entity having earned one or more certifications. This may, for instance, correspond to the example described above in reference to FIG. 3D in which the ranking engine 160 determines that Farragut Terrace and the Dupont Apartment building are LEED certified. In some implementations, determining that the particular resource among the set of resources includes listing information for one or more properties that have the particular attribute that has been indicated as verified by the third party listing information verification service may include determining that the particular resource among the set of resources includes listing information for one or more properties that has been indicated by the third party listing information verification service as being owned or managed by an entity having passed a background check. This may, for instance, correspond to the example described above in reference to FIG. 3D in which the ranking engine 160 determines that Farragut Terrace and L'Enfant Towers are owned or managed by verified property managers that have passed one or more background checks administered by the third party verification service.

In some implementations, the listing information of the particular resource indicates one or more features or amenities of one or more properties. In such implementations, determining that the particular resource among the set of resources includes listing information for one or more properties that have the particular attribute that has been indicated as verified by the third party listing information verification service may include determining that the particular resource among the set of resources includes listing information for one or more properties have been indicated as verified by the third party listing information verification service to include the one or more features or amenities. This may, for instance, correspond to the example described above in reference to FIG. 3D in which the ranking engine 160 determines that the listings for Farragut Terrace and L'Enfant Towers are verified, and thus include information that is considered to be relatively reliable and/or accurate.

In some implementations, making one or more determinations about a particular resource among the set of resources may include determining that a particular resource among the set of resources includes a particular type of content. In these implementations, ranking the particular resource among the set of resources based at least on the one or more determinations may include ranking the particular resource among the set of resources based at least on determining that the particular resource among the set of resources includes the particular type of content. For instance, this may correspond to determining that a particular resource includes content such as images, video, audio, and the like, and ranking the particular resource among the set of resources by quantity and/or type of included content. In some examples, such rankings may favor resources that include more content than those that include less content.

Although described within the exemplary context of situations in which multiple search results are identified as responsive to a query, it is to be understood that the principles of the techniques described in association with FIGS. 1-4 may be applied, at least in part, in situations in which zero or more search results are identified as responsive to a query. It is to be further understood that services and communications provided in association with the techniques described herein may be provided in any number of different languages, such as English and Spanish.

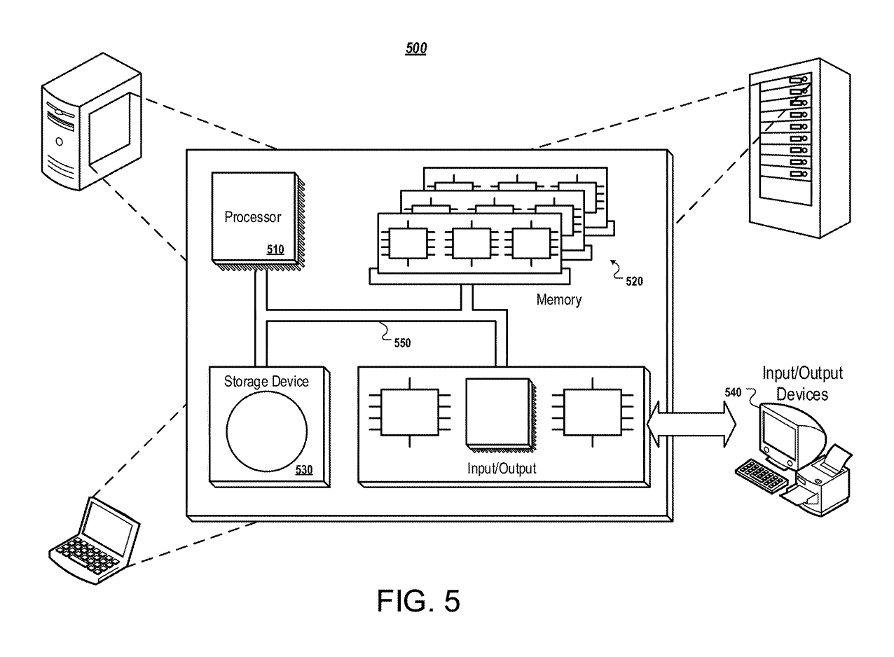

FIG. 5 is a schematic diagram of an example of a generic computer system 500. The system 500 can be used for the operations described in association with FIGS. 1-3 according to some implementations. The system 500 may include system 100, may provide one or more of graphical user interfaces 200 and 300A-300D, and may perform process 400.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

What is claimed is:

1-8. (canceled)

9. A computer-implemented method comprising:
receiving, by a front-end application server of a real estate listing search system that includes (i) the front-end application server, (ii) a location based search engine server, and (iii) a ranking engine server, a query that specifies a geographic region;
obtaining, by the location based search engine server of the real estate listing search system, a set of real estate listings that (i) are each identified as responsive to the query and (ii) each include listing information for one or more properties located within the geographic region;
after the location based search engine server obtains the set of real estate listings, determining, by the ranking engine server of the real estate listing search system, that a particular real estate listing among the set of real estate listings that (i) are each identified as responsive to the query and (ii) each include listing information for one or more properties located within the geographic region includes listing information that was supplied through a particular listing information interface selected from among (a) a graphical user interface associated with the real estate listing search system that requires a user to manually input listing information, and (b) an application programming interface (API) which automatically receives listing information from another computing device;
determining, by the ranking engine server of the real estate listing search system, a weight by which to weight a ranking score for the particular resource based on determining that the listing information included in the particular real estate listing was supplied through the particular listing information interface, wherein the weight favors ranking scores that are each associated with resources whose listing information was supplied through an API over ranking scores that are each associated with resources whose listing information was manually input through a graphical user interface associated with the real estate listing search system;
weighting, by the ranking engine server of the real estate listing search system, a ranking score for the particular resource based on the determined weight;
ranking, by the ranking engine server of the real estate listing search system, the particular real estate listing among the set of real estate listings based at least on the weighted ranking score; and
providing, the front end application server of the real estate listing search system, a real estate listing results page that includes (i) an indication of the particular resource's ranking among the set of resources, and (ii) an indication that the listing information was supplied through the particular listing information interface.

10-11. (canceled)

12. The computer-implemented method of claim 9, further comprising:
determining that the particular resource that (i) are each identified as responsive to the query and (ii) each include listing information for one or more properties located within the geographic region includes listing information for one or more properties that reside at a particular location within the geographic region;
generating one or more representations of the particular resource, at least one of which indicates the particular location within the geographic region; and
wherein providing the indication of the particular resource's ranking among the set of resources comprises providing the one or more representations of the particular resource, with indication of the particular resource's ranking among the set of resources, for output.

13. A computer-implemented method comprising:
receiving, by a front-end application server of a real estate listing search system that includes (i) the front-end application server, (ii) a location based search engine server, and (iii) a ranking engine server, a query that specifies a geographic region and a price range;
obtaining, by the location based search engine server of the real estate listing search system, a set of real estate listings that (i) are each identified as responsive to the query, (ii) each include listing information for one or more properties located within the geographic region, (iii) include one or more properties having a respective price that is included in the price range specified by the query and one or more properties having a respective price that exceeds the price range specified in the query
after the location based search engine server obtains the set of real estate listings, determining, by the ranking engine server of the real estate listing search system, that a particular real estate listing among the set of real estate listings that (i) are each identified as responsive to the query, (ii) each include listing information for one or more properties located within the geographic region, and (iii) include one or more properties having a respective price that is included in the price range specified by the query and one or more properties having a respective price that exceeds the price range specified in the query, listing information for one or more of the properties having prices that exceed the price range specified in the query by a particular amount;
determining, by the ranking engine server of the real estate listing search system, a difference between the prices of the one or more properties that exceed the price range specified in the query and the particular amount;
weighting, by the ranking engine server of the real estate listing search system, a ranking score for the particular resource based on the determined difference between the prices of the one or more properties and the particular amount, wherein weighting the ranking score favors resources whose listing information includes properties having prices that exceed the price range specified in the query by the particular amount over resources whose listing information includes properties having prices that do not exceed the price range specified in the query by the particular amount;
ranking, by the ranking engine server of the real estate listing search system, the particular real estate listing among the set of real estate listings based at least on the weighted ranking score; and
providing, the front end application server of the real estate listing search system, a real estate listing results page that includes (i) an indication of the particular resource's ranking among the set of resources, and (ii) an indication of the difference between the prices of the one or more properties and the particular amount.

14. The computer-implemented method of claim 13,
wherein receiving the query that specifies the geographic region and the price range comprises:
receiving a query that specifies a geographic region and a price range that extends from a lower limit to an upper limit; and
wherein the computer-implemented method further comprises:
based at least on the received price range, determining a particular price range that (i) is different from the received price range and (ii) extends from the upper limit of the received price range to another limit that exceeds the upper limit of the price range.

15. The computer-implemented method of claim 14, wherein determining that the particular real estate listing among the set of real estate listings that (i) are each identified as responsive to the query and (ii) each include listing information for one or more properties located within the geographic region includes listing information for one or more properties having prices that exceed the price range by the particular amount comprises:
determining that the particular real estate listing among the set of real estate listings that (i) are each identified as responsive to the query and (ii) each include listing information for one or more properties located within the geographic region includes listing information for one or more properties having prices that fall within the particular price range.

16. The computer-implemented method of claim 15, further comprising:
generating one or more representations of the particular real estate listing, at least one of which indicates that the particular real estate listing that (i) are each identified as responsive to the query and (ii) each include listing information for one or more properties located within the geographic region includes listing information for one or more properties having prices that fall within the particular price range; and
wherein providing the indication of the particular real estate listing's ranking among the set of real estate listings comprises providing the one or more representations of the particular real estate listing, with indication of the particular real estate listing's ranking among the set of real estate listings, for output.

17. A computer-implemented method comprising:
receiving, by a front-end application server of a real estate listing search system that includes (i) the front-end application server, (ii) a location based search engine server, and (iii) a ranking engine server, a query that specifies a geographic region;
obtaining, by the location based search engine server of the real estate listing search system, a set of real estate listings that (i) are each identified as responsive to the query and (ii) each include listing information for one or more properties located within the geographic region;
after the location based search engine server obtains the set of real estate listings, determining, by the ranking engine server of the real estate listing search system, that a particular real estate listing among the set of real estate listings that (i) are each identified as responsive to the query and (ii) each include listing information for one or more properties located within the geographic region listing information for one or more properties that have a particular attribute that has been indicated as verified by a third party listing information verification service;
determining, by the ranking engine server of the real estate listing search system, a weight by which to weight a ranking score for the particular resource based on the listing information indicating that the one or more properties have the particular attribute that has been verified by the third party listing information verification service, wherein the weight favors ranking scores that are each associated with resources whose listing information indicates that the one or more properties have the particular attribute that has been verified by the third party listing information verification service over ranking scores that are each associated with resources whose listing information indicates that the one or more properties do not have the particular attribute that has been verified by the third party listing information verification service;
weighting, by the ranking engine server of the real estate listing search engine, the ranking score for the particular resource based on the determined weight;
ranking, by the ranking engine server of the real estate listing search system, the particular real estate listing among the set of real estate listings based at least on the weighted ranking score; and
providing, the front end application server of the real estate listing search system, a real estate listing results page that includes (i) an indication of the particular resource's ranking among the set of resources, and (ii) an indication that the one or more properties have the particular attribute that has been verified by the third party listing information verification service.

18. The computer-implemented method of claim 17, wherein determining that the particular real estate listing among the set of real estate listings that (i) are each identified as responsive to the query and (ii) each include listing information for one or more properties located within the geographic region includes listing information for one or more properties that have the particular attribute that has been indicated as verified by the third party listing information verification service comprises:
determining that the particular real estate listing among the set of real estate listings that (i) are each identified as responsive to the query and (ii) each include listing information for one or more properties located within the geographic region includes listing information for one or more properties that has been indicated by the third party listing information verification service as being owned or managed by an entity having earned one or more certifications.

19. The computer-implemented method of claim 17, wherein determining that the particular real estate listing among the set of real estate listings that (i) are each identified as responsive to the query and (ii) each include listing information for one or more properties located within the geographic region includes listing information for one or more properties that have the particular attribute that has been indicated as verified by the third party listing information verification service comprises:
determining that the particular real estate listing among the set of real estate listings that (i) are each identified as responsive to the query and (ii) each include listing information for one or more properties located within the geographic region includes listing information for one or more properties that has been indicated by the third party listing information verification service as being owned or managed by an entity having passed a background check.

20. The computer-implemented method of claim 17,
wherein the listing information of the particular real estate listing indicates one or more features or amenities of one or more properties; and
wherein determining that the particular real estate listing among the set of real estate listings that (i) are each identified as responsive to the query and (ii) each include listing information for one or more properties located within the geographic region includes listing information for one or more properties that have the particular attribute that has been indicated as verified by the third party listing information verification service comprises:
determining that the particular real estate listing among the set of real estate listings that (i) are each identified as responsive to the query and (ii) each include listing information for one or more properties located within the geographic region includes listing information for one or more properties have been indicated as verified by the third party listing information verification service to include the one or more features or amenities.
